(19) United States
(12) Patent Application Publication
(10) Pub. No.: US 2016/0140505 A1
(43) Pub. Date: May 19, 2016

(54) ASSEMBLING INFORMATION TO GENERATE COMPOSITE WEB PAGE CONTENT

(71) Applicant: LinkedIn Corporation, Mountain View, CA (US)

(72) Inventors: Naveen Gupta, Sunnyvale, CA (US); Jaygiri Goswami, Bangalore (IN); Manish Satyapal Gupta, Bangalore (IN)

(21) Appl. No.: 14/937,734

(22) Filed: Nov. 10, 2015

Related U.S. Application Data
(63) Continuation of application No. 12/501,685, filed on Jul. 13, 2009.

(51) Int. Cl. G06Q 10/10; G06F 17/30

(52) U.S. Cl. CPC G06Q 10/1053; G06F 17/30882

(57) ABSTRACT

Disclosed herein is a system and method relating to a listing service's listings, such as job listings of a recruitment service, targeted for a user using targeting information collected external to the listing service. A number of listings are identified for the user using the externally-collected targeting information and information obtained from the listing service including information about listings of the listing service. The user-targeted listing service listings are provided to the user outside the listing service's notifications, such as in a web page provided by a service other than the listing service.

### CROSS-REFERENCE TO RELATED APPLICATIONS; BENEFIT CLAIM

This application claims the benefit as a Continuation of application Ser. No. 12/501,685, filed Jul. 13, 2009, the entire contents of which is hereby incorporated by reference as if fully set forth herein, under 35 U.S.C. §120. The applicant(s) hereby rescind any disclaimer of claim scope in the parent application(s) or the prosecution history thereof and advise the USPTO that the claims in this application may be broader than any claim in the parent application.

### FIELD OF THE INVENTION

This disclosure relates to listings, such as job listings, targeted for a user, and more particularly to identifying a number of listings for a user and providing the user-targeted listings in a web page, such as a page displayed by a browser application.

### BACKGROUND

Using an online listing service, such as a recruitment service, users, e.g., employers and job candidates, can, among other things, post and search listings, such as job openings and candidate resumes. A registered user accesses the service via the listing service's web site, e.g., the user points a browser application to the web site using a universal resource locator (URL) input to the browser application. A user posting a listing provides the listing information, e.g., a potential employer seeking to fill a position provides information about the position, such as location, salary, prerequisites including such things as skills, experience and education, etc. A user interested in a listing typically provides some information to evidence an interest in the listing, e.g., a potential employee can provide a resume identifying the user's skills, experience, education, salary requirements, etc. Other listing services, such as real estate, etc. are also available online.

### SUMMARY

To be most effective, a listing service must be able to attract users. By way of a non-limiting example, a recruitment service relies on both potential employers posting job listings and potential employees being able to fill the posted positions. In some cases, a potential employee may not be actively looking for a job, but might still be interested enough in a position to accept the position. Such an individual is not likely to access the service and therefore is not likely to discover that the position is available. A potential employer may not be actively looking for an employee, but might be interested in an individual that has certain experience, skills, education, etc. of interest to the potential employer. It would be beneficial to be able to identify one or more listings, e.g., one or more job openings or candidates in a recruitment listing service, that might be of interest to a potential employer, or employee, and to be able to provide the one or more listings, such as in a display region of a web page other than the listing service's web page. In so doing, it is possible to notify a user of listings provided by the listing service that might be of interest to the user even in a case that the user is not accessing the listing service.

The present disclosure seeks to address failings in the art and to provide a system and method to identify one or more listings of a listing service targeted for a user, the user-targeted one or more listings being provided to a user other than by the listing service, such as in a web page provided by a service other than the listing service. Disclosed herein is a system and method relating to a listing service's listings, such as job listings of a recruitment service, targeted for a user using targeting information collected external to the listing service. A number of listings are identified for the user using the externally-collected targeting information and information obtained from the listing service including information about listings of the listing service. The user-targeted listing service listings are provided to the user outside the listing service, such as in a web page provided by a service other than the listing service.

In accordance with one or more embodiments, a method is provided, which comprises collecting targeting information for a user, the targeting information being information other than listing service information and comprising intent information identified using user input collected from a web page of a service other than the listing service; identifying at least one listing from a plurality of listings maintained by the listing service, each listing being identified using the targeting information and information obtained from the listing service including information about the listing; and providing the at least one listing service listing to the user.

A computer-readable medium is provided, in accordance with one or more embodiments, the medium tangibly storing thereon computer-executable process steps comprising steps of collecting targeting information for a user, the targeting information being information other than listing service information and comprising intent information identified using user input collected from a web page of a service other than the listing service; identifying at least one listing from a plurality of listings maintained by the listing service, each listing being identified using the targeting information and information obtained from the listing service including information about the listing; and providing the at least one listing service listing to the user.

In accordance with one or more embodiments, a system comprising at least one computer device having a processing unit configured to provide a target information collector collecting targeting information for a user, the targeting information being information other than listing service information and comprising intent information identified using user input collected from a web page of a service other than the listing service; a listing selector identifying at least one listing from a plurality of listings maintained by the listing service, each listing being identified using the targeting information and information obtained from the listing service including information about the listing; and a listing notifier providing the at least one listing service listing to the user.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code to implement functionality in accordance with one or more such embodiments is embodied in, by and/or on a computer-readable medium.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 provides a component overview in accordance with one or more embodiments of the present disclosure.

FIG. 2, which comprises FIGS. 2A and 2B, provides an example of a display of listing service listings in accordance with one or more embodiments of the present disclosure.

FIG. 3 provides a user-targeted listing selection process flow for user in accordance with one or more embodiments of the present disclosure.

FIG. 4 provides a listing selection process flow for use in accordance with one or more embodiments of the present disclosure.

FIG. 5 illustrates another component overview that can be used in connection with one or more embodiments of the present disclosure.

FIG. 6 is a detailed block diagram illustrating an internal architecture of a computing device in accordance with one or more embodiments of the present disclosure.

### DETAILED DESCRIPTION

In general, the present disclosure includes a user-targeted listings system, method and architecture.

Certain embodiments of the present disclosure will now be discussed with reference to the aforementioned figures, wherein like reference numerals refer to like components.

In accordance with one or more embodiments, one or more listings of a listing service are identified, which are targeted for a user, the user-targeted one or more listings are then provided to a user outside the listing service. In accordance with one or more embodiments the user-targeted listings are provided outside the listing service, e.g., apart from any notification, such as display, messages, etc., provided by the listing service. In so doing, the user-targeted listings can be used to attract the user interested in the user-targeted listings provided outside the listing service to access the listing service. Once the user accesses the listing service, the user can pursue a user-targeted listing, or any other listing offered by the listing service. In accordance with one or more embodiments, the user-targeted listings can be provided to the user in a browser's web page provided by a service other than the listing service.

In accordance with one or more embodiments disclosed herein, a system and method operate on a listing service's listings, such as job listings of a recruitment service, identify at least one of the listing service's listings, each of the identified listings is targeted for a user using targeting information collected for the user external to the listing service. A number of listings are identified for the user using the externally-collected targeting information and information obtained from the listing service including information about listings of the listing service. The user-targeted listing service listings are provided to the user outside the listing service, such as in a web page provided by a service other than the listing service. Although embodiments are described herein in connection with a recruitment listing service, other listing services are contemplated. Yahoo!®, for instance, operates several listing services, such as Yahoo!® Auctions, Yahoo!® Personals, Hot Jobs®, Yahoo!® Real Estate, and Yahoo!® Autos, to name a few. Each of these services permit users to view listings and initiate various actions, for example, to purchase goods, bid on an auction, meet other people, search for a job, or inquire about a used car.

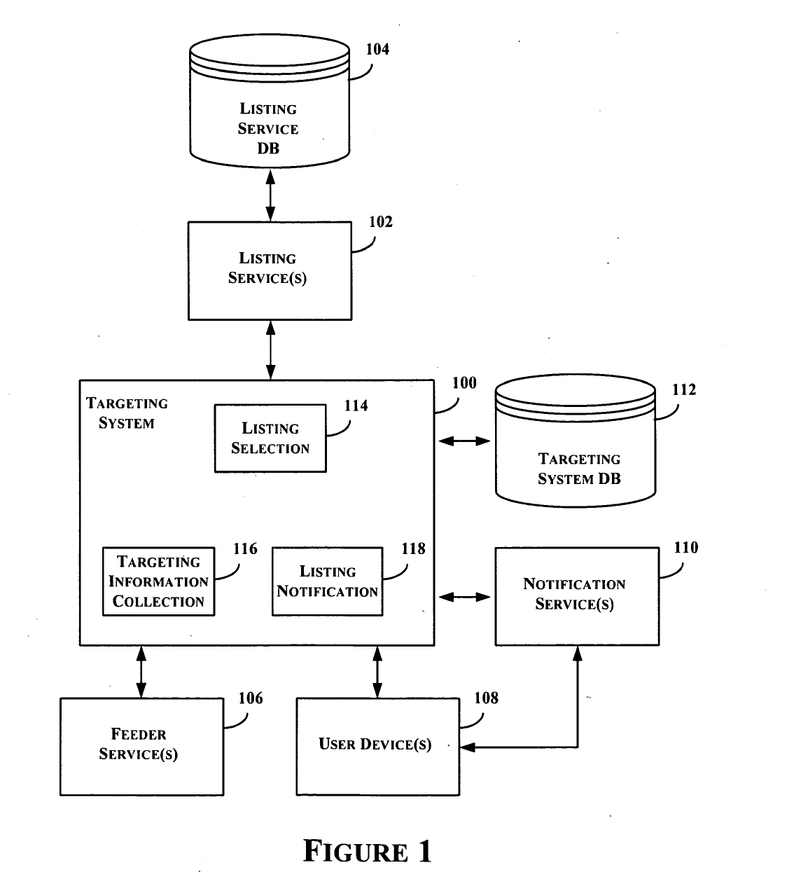

FIG. 1 provides a component overview in accordance with one or more embodiments of the present disclosure. Targeting system 100 comprises one or more modules, or components, used in accordance with one or more embodiments to collect targeting information for a user, identify one or more listings from a plurality of listings maintained by a listing service, and provide the identified listings to the user. In accordance with one or more embodiments, the targeting information is collected, and the one or more identified listings are provided to the user, outside the listing service. In accordance with one or more embodiments, the terminology “outside” the listing service is synonymous with the terminology “external to,” “apart from,” and “beyond” the listing service, and is intended to refer to processes and/or mechanisms other than those provided by the listing service from which user-targeted listings are being selected.

In accordance with one or more embodiments, the processes and/or mechanisms provided in accordance with one or more embodiments, which are external to the listing service, can be used in combination with the processes and/or mechanisms provided by the listing service. By way of one non-limiting example, in accordance with one or more embodiments, one or more listings of a listing service are identified using targeting information collected external to the listing service and information obtained from the listing service; the information obtained from the listing service comprising listing information, and can comprise user information, collected by the listing service.

Targeting system 100, in particular targeting information collection, or targeting information collector, 116 of targeting system 100, can collect targeting information for a user from a plurality of sources. By way of some non-limiting examples, targeting system 100 can collect targeting information from one or more feeder services 106, which can be provided by one or more computing devices configured to provide a service or services, information from one or more listing services 102, information from one or more user devices 106, etc. By way of a further non-limiting example, a feeder service 106 can be a web search service, such as that provided by Yahoo!®, or other services such as Yahoo!® Answers, Yahoo!® Chat, Yahoo!® Groups, etc. In accordance with one or more embodiments, feeder service 106 can be any service that has the capacity to provide information about a user to targeting system 100. In accordance with one or more embodiments, a listing service other than the listing service for which listings are identified can be a feeder service 106. By way of a non-limiting example, a real estate listing service can be used to provide information, such as a user's geographic location, to the targeting system 100 for use in targeting job listings that are available in the user's geographic location. In accordance with one or more embodiments, an agent, or other software and/or hardware component, residing on a user device 108 can be used to collect targeting information, which is transmitted by the agent to targeting information collection module 116, e.g. via a network. In accordance with one or more embodiments, information collected by targeting information collection module 116 can be stored in a data store, such as targeting system database (DB) 112.

In accordance with one or more embodiments, listing selection module, or listing selector, 114 identifies at least one listing from a plurality of listings maintained by the listing service 102, each listing is identified using listing information obtained from the listing service 102 and the targeting information collected by targeting information collection module 116. In accordance with one or more embodiments, information obtained from a listing service 102 other than listing information can be used by listing selection module 114. By way of a non-limiting example, such other information can include user information, e.g., address, employment, educational, etc. information, collected by the listing service 102. In accordance with one or more embodiments, information that is maintained by listing service 102 can be stored in one or more data stores, such as listing service DB 104. As is discussed more fully below, listing selection module 114 can use relevance, availability and/or user engagement determinations as criteria to select the one or more user-targeted listings.

In accordance with one or more embodiments, a user can be anyone that may have an interest in listings, and/or services, provided by a listing service. By way of some non-limiting example, the user can be one who may be interested in posting a listing with the listing service, or one who wishes to pursue a listing posted with the listing service. By way of a further non-limiting example, a user can be a potential employee, and listing selection module 114 can select a number of user-targeted job listings posted to a recruitment service, such as Hot Jobs®, for the potential employee; and/or the user can be a potential employer, and the listing selection module 114 can select a number of user-targeted resumes posted to the recruitment service for the potential employer.

In accordance with one or more embodiments, listing notification module, or listing notifier, 118 can have the capability to communicate the user-targeted listings to the user, e.g. via user device 108, or provide the user-targeted listings to notification service 110, which communicates the user-targeted listings to the user's device 108. It is contemplated that any mechanism now known or later developed can be used to communicate the user-targeted listings. By way of some non-limiting examples, the user-targeted listings can be communicated to the user's device 108 as part of a web page that can be displayed by a browser executing on user device 108, in a message communicated to the user device 108 via a messaging system, such as an electronic mail messaging system, instant messaging system, text messaging system, voice mail messaging system, etc., a push or pull web, or news, feed system, such as really simple syndication (RSS), a telephone system, such as a plain old telephone service (POTS), or a mobile phone service using any of the mobile phone standards, such as global system for mobile communications (GSM) standard(s), code division multiple access (CDMA) mobile communication standard(s), etc.

In accordance with one or more embodiments, the notification service 110 used to provide the user-targeted listings is external to any notification service provided by the listing service 102. By way of a non-limiting example, user-targeted listings identified by listing selection module 114 can be provided in a page that provides web search results provided by a web search service, or in any other page provided by a web site accessed by the user's device 108. By way of some further non-limiting examples, user-targeted listings can be provided in an email, voice, text and/or instant message, and/or a web feed, which contains content that is unrelated to the listing service 102 from which the user-targeted listings were selected. By way of a further non-limiting example, user-targeted listings can be provided in any type of user interface and can be delivered as audio, video or some combination of audio and video.

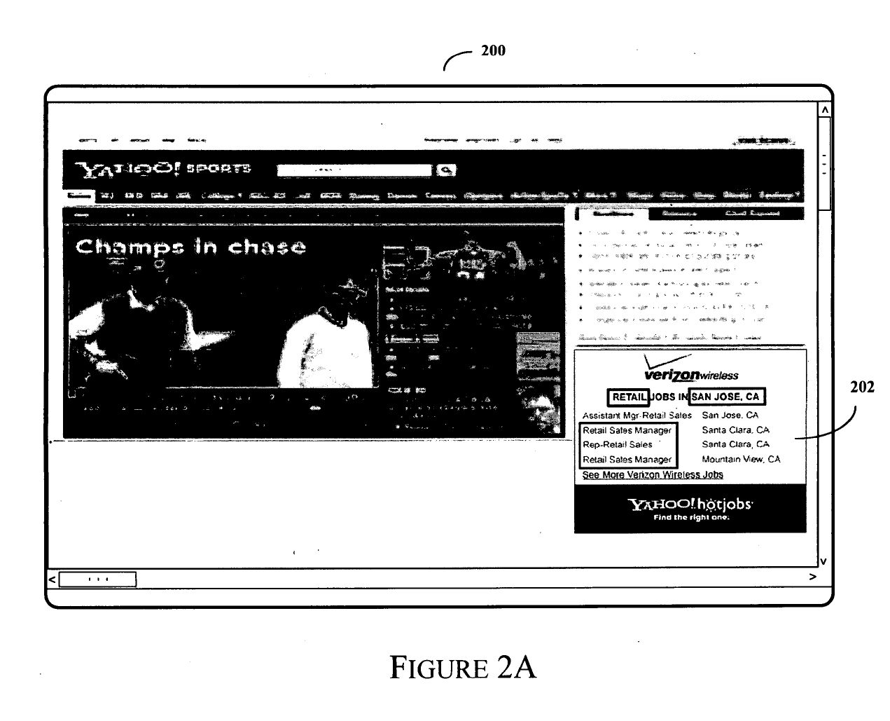

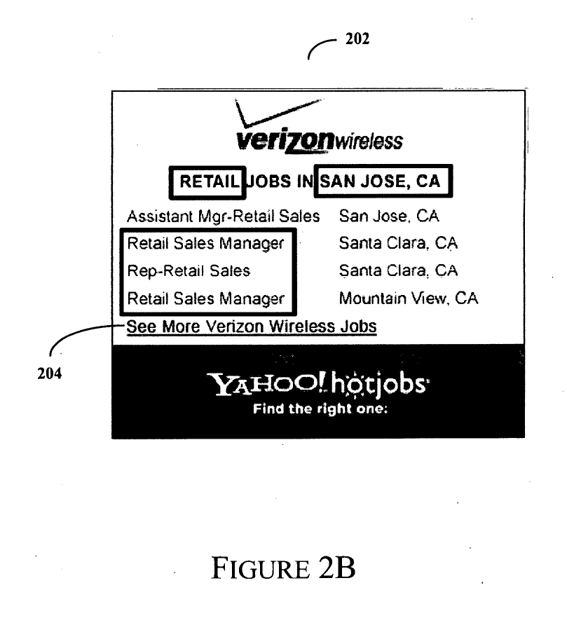

FIG. 2, which comprises FIGS. 2A and 2B, provides an example of a display of listing service listings in a web page in accordance with one or more embodiments of the present disclosure. In the example shown in FIG. 2A, portion 202 of page 200 displays job listings targeted for the user. The remainder of page 200 displays contents unrelated to the user-targeted listings. In the example, the unrelated contents comprise sports-related contents, i.e., a story about a golf tournament, sports-related headlines, etc. With reference to FIG. 2B, portion 202 comprises a listing of retail jobs selected from the listings in a recruitment listing service, such as Hot Jobs®. In the example, all of the listings are for retail jobs in San Jose, or a neighboring city. The job listings are selected using targeting information comprising information used to determine that the user is interested in a management position in retail sales in San Jose, for example. The listings are selected and/or sorted based on one or more selection/sort criteria. In the example shown in FIG. 2B, the criteria includes relevance, with a location being the primary relevance indicator, so that the first listing is for an assistant manager position in retail sales located in San Jose, the second and third listings are for positions in Santa Clara, Calif., which is some distance from San Jose, and the fourth listing is for a position in Mountain View, Calif., which is a further distance from San Jose than Santa Clara. In the example, as illustrated with the Santa Clara listings, a position criterion is also used as an indicator of relevance, so that, for a user indicated in a management position, the management position located in Santa Clara is listed before the representative position in Santa Clara. Furthermore, other factors such as click through rates of the respective listings, user's rate of expression of interest in the listings, bidding price for the listing, etc., can be used as an indicator of relevance and/or to sort the listings.

In accordance with one or more embodiments, portion 202 of page 200 includes one or more hyperlinks, e.g., hyperlink 204, which can be used to access the listing service 102. In accordance with one or more embodiments, at least one of the user-targeted listings can be associated with a hyperlink. By way of some non-limiting examples, user selection of a hyperlink can take the user to a display provided by the listing service 102 of at least the user-targeted listings, to a display allowing the user to search for other listings, a display inviting the user to register with the listing service 102, the main display of the listing service 102, or some combination of displays.

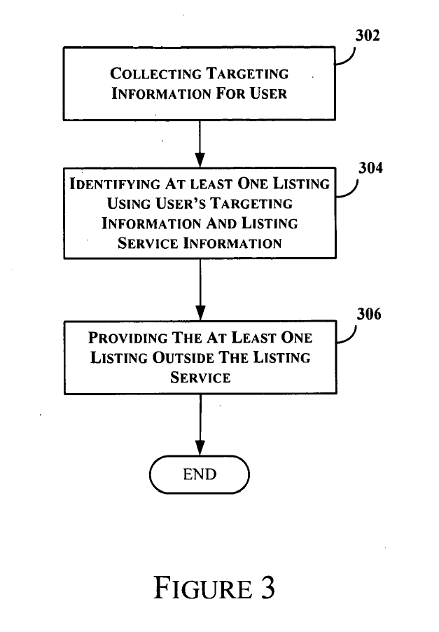

FIG. 3 provides a user-targeted listing selection process flow for user in accordance with one or more embodiments of the present disclosure. At step 302, targeting information for a user is collected. In accordance with one or more embodiments, the targeting information is collected external to the listing service from which listings are selected for the user. In accordance with one or more such embodiments, targeting information used to select listings from one listing service can be collected from another listing service, a feeder service 106, a user device 108, etc.

At step 304, one or more listings are identified from a plurality of listings maintained by the listing service 102 for a user using the targeting information collected for the user. Each listing identified at step 304 is identified using listing information, which is obtained from the listing service 102 for purposes of making the identification, and further using the targeting information collected at step 302. In accordance with one or more embodiments, information other than listing information, e.g., user information, can also be obtained from the listing service 102, and used with the targeting information and the listing information to identify the one or more listings.

At step 306, the identified listing(s) are provided to the user. In accordance with one or more embodiments, the identified listing(s) are provided to the user using one or more of the techniques discussed above.

Referring again to step 304, one or more criteria are used to select the listing(s) identified at step 304. In accordance with one or more embodiments, such criteria include, without limitation, relevance, availability, and user engagement. In accordance with one or more such embodiments, relevance can be determined using targeting information collected from observed behavior of the user and/or keyword input from the user. In accordance with one or more embodiments, the behavioral and/or keyword targeting information can be used to identify intent of the user, which can then be used to match the user's intent with listing information to identify a level of relevance of the listing to the user. It is contemplated that any information collected for the user can be used as targeting information, which can be compared with information maintained for a listing by the listing service 102 to determine the listing's relevance to the user. By way of a non-limiting example, behavioral and/or keyword targeting information can be collected from input by the user to one or more feeder services 106, such as the user's interaction with a search service, e.g., using one or more of the keywords “retail” “management” “openings,” etc.; the user's interaction with a question & answer (Q & A) and/or chat group service, e.g., “what skills are needed to qualify for management in retail sales;” the user's interaction with a listing service, e.g., interest in real estate listings in San Jose; and/or the user visiting a web page belonging to a particular category or type, such as a user group of retail employees.

In accordance with one or more embodiments a user's geographic location can be determined using an Internet Protocol (IP) address of the user. By way of a non-limiting example, information supplied by the Regional Internet Registry (RIR), a governing body responsible for the administration of Internet addresses in a specific geographic region, is used to determine the user's geographic location using the user's IP address. An RIR database tracks IP addresses, Internet Service Providers (ISPs), and general geographic location. Using information contained in the RIR database, geographic location information, e.g., street, city and/or state information, can be determined using the user's IP address. It should be apparent that a user's geographic location can be determined using other techniques, including without limitation, a GPS-enabled device, mobile device cell tower location, user-supplied location information, user profile information, etc. By way of some non-limiting example, the user-supplied information can comprise information provided by the user during registration, such as that provided during registration with a feeder service 106 and/or a listing service 102, for example, information extracted from a query input by the user to a search service, such as a search for show times at a movie theatre in San Jose, requesting weather information for San Jose from a weather service, etc.

In accordance with one or more embodiments, a level of availability can be determined for a listing, and the determined level of availability can be used to select the listing as one of the listings identified at step 304. In accordance with one or more such embodiments, availability of a listing can be determined using an age associated with the listing, e.g., the age can comprise a posting date of the listing, which can be used with the current date to determine how long ago the listing was posted. In accordance with one or more such embodiments, information that identifies the number of people that have pursued the listing, e.g., the number of people that have applied for a job, can be used to determine availability. By way of a non-limiting example, the likelihood that a listing is still “open” decreases as the listing ages and/or as the number of people pursuing the listing increases. By way of some further non-limiting example, a job listing that was posted several months ago is likely to already be filled or the employer is no longer looking to fill the position, and/or a job listing that has had a number of interested users applying for the job is likely already filled. The determined availability level for listings being considered at step 304 can be taken into account in identifying, or selecting, the listings for the user.

In accordance with one or more embodiments, a level of user engagement, or predicted user engagement, can be determined based on other user's engagement with the listing. By way of a non-limiting example, the number of users viewing a listing, e.g., the number of users that select the listing for review, can be used to determine the level of engagement. By way of another non-limiting example, the level of engagement can be expressed as a ratio of the number of user that showed interest in a listing to the number of users that were provided with the listing, e.g., a click through rate. In accordance with one or more embodiments, the ratio can be based on behavior of users interacting with a listing service, e.g., the listing service from which the listings are selected, behavior of users outside the listing service from which the listings are selected, or some combination.

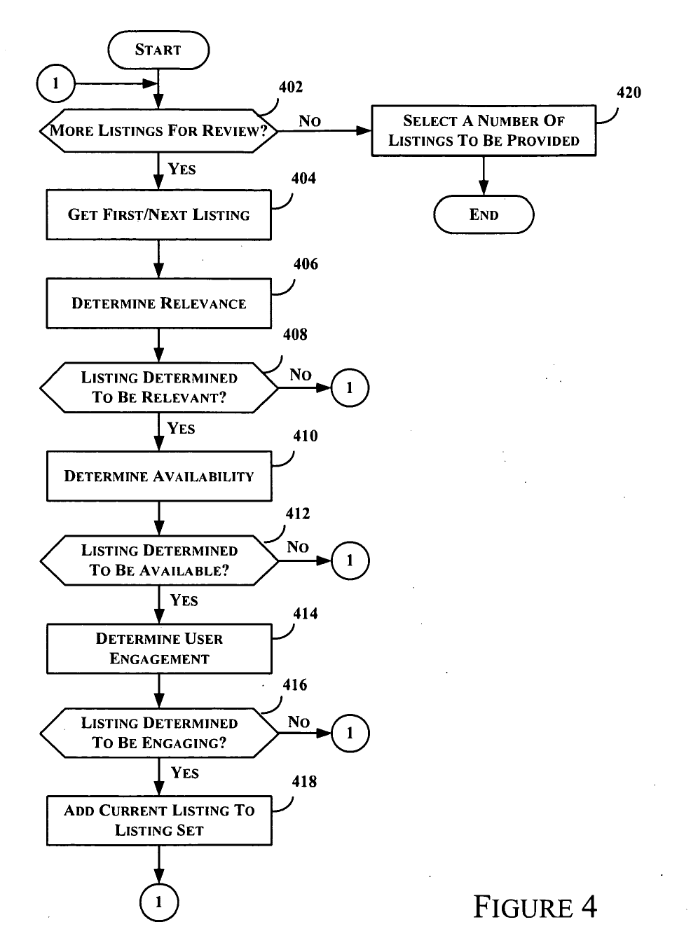

FIG. 4 provides a listing selection process flow for use in accordance with one or more embodiments of the present disclosure. In accordance with one or more embodiments, the process flow of FIG. 4 can be implemented in listing selection module 114 of targeting system 100. In accordance with one or more such embodiments, process flow determinations can be made by a determination module, or determiner, of listing selection module 114. At step 402, a determination is made whether any listing remains to be reviewed. If there are more listings available for review, processing continues at step 404 to get the next, or first, listing. At step 406, the relevance of the listing is determined using targeting information, such as behavioral and keyword targeting and location targeting information, as criteria in comparison with listing information obtained from the listing service 102.

At step 408, a determination is made whether or not the current listing is relevant. By way of a non-limiting example, a listing can be determined to be irrelevant if it is located outside a geographic region that includes the location identified for the user and/or the listing does not match the targeting information collected for the user. In accordance with one or more embodiments, a relevance score can be calculated and compared to a relevance threshold to make the determination at step 408. If the listing is considered to not be relevant, processing continues at step 402 to make a determination whether any more listings remain to be reviewed. If the current listing is determined, at step 408, to be relevant, processing continues at step 410 to determine the listing's availability. At step 412, a determination is made whether a determined level of availability for the listing satisfies a threshold availability. By way of a non-limiting example, an age threshold and/or a pursuit threshold can be used to determine whether the listing is available. If it is determined, at step 412, that the listing is not available, processing continues at step 402 to process any remaining listings. If it is determined that the listing is available, processing continues at step 414 to determine a level of user engagement for the listing.

At step 414, a level of user engagement is determined for the listing. At step 416, the level of engagement is examined to make a determination whether or not the listing is engaging enough, e.g., the listing satisfies a threshold level of engagement. If not, processing continues at step 402 to process any remaining listings. If the listing is determined to be engaging, processing continues at step 418 to add the current listing to a set of listings, and processing continues at step 402 to process any remaining listings.

If it is determined at step 402 that there are no more listings remaining to be processed, processing continues at step 420 to select a number of the listings, which are to be provided to the user. In accordance with one or more embodiments, a number of listings determined to be the most relevant, the most available, and the most engaging of the listing in the listing set generated at step 418 are selected for the user. In accordance with one or more such embodiments, the number of listings that are selected can be based on constraints of the notification service 110. By way of a non-limiting example, the number of listings selected can be based on the size of portion 202 in page 200. By way of another non-limiting example, the number of listings selected can be determined based on message size constraints of a messaging service. By way of yet another non-limiting example, the number listings selected can be based on an empirical understanding of user attention levels.

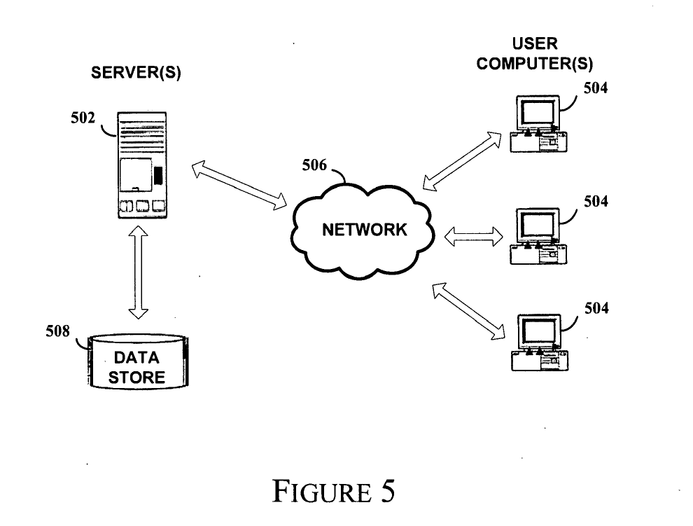

FIG. 5 illustrates another component overview that can be used in connection with one or more embodiments of the present disclosure. In accordance with one or more embodiments of the present disclosure, one or more computing devices, e.g., one or more servers and/or user computing devices are configured to comprise functionality described herein. For example, one or more instances of computing device 502, or device 504, can be configured to collect targeting information for a user, identify at least one user-targeted listing service listing and cause the user-targeted listing(s) to be communicated to the user in accordance with one or more embodiments of the present disclosure.

In accordance with one or more embodiments, server 502 can serve data, e.g., content, web pages, applets, etc., to user computing devices 504, and receive data, e.g., targeting information, from user computing devices 504, using a browser application and a network 506. Data store 508 can be used to store data, including data served to a user computer 504, as well as data used by server 502, e.g., applications, drivers, etc. executed by the server 502. Data store 508 can be one or more physical stores. Examples of data store 508 include listing service DB 104 and targeting system 112, for example.

The user computer 504 can be any computing device, including without limitation a personal computer, personal digital assistant (PDA), wireless device, cell phone, internet appliance, media player, home theater system, and media center, or the like. For the purposes of this disclosure a computing device includes a processor and memory for storing and executing program code, data and software, and may be provided with an operating system that allows the execution of software applications in order to manipulate data. A computing device such as server 502 and user computer 504 can include one or more processors, memory, a removable media reader, network interface, display and interface, and one or more input devices, e.g., keyboard, keypad, mouse, etc. and input device interface, for example. One skilled in the art will recognize that server 502 and user computer 504 may be configured in many different ways and implemented using many different combinations of hardware, software, or firmware. A discussion of an internal architecture of a computing device is discussed further below.

In accordance with one or more embodiments, server 502 can make a user interface available to a user computer 504 via the network 506. The user interface made available to the user computer 504 can include one or more user-targeted listings in accordance with one or more embodiments of the present disclosure. In accordance with one or more embodiments, server 502 makes a user interface available to a user computer 504 by communicating a definition of the user interface to the user computer 504 via the network 506. The user interface definition can be specified using any of a number of languages, including without limitation a markup language such as Hypertext Markup Language, scripts, applets and the like. The user interface definition can be processed by an application executing on the user computer 504, such as a browser application, to output the user interface on a display coupled, e.g., a display directly or indirectly connected, to the user computer 504.

In an embodiment, network 506 may be the Internet, an intranet (a private version of the Internet), or any other type of network. An intranet is a computer network allowing data transfer between computing devices on the network. Such a network may comprise personal computers, mainframes, servers, network-enabled hard drives, and any other computing device capable of connecting to other computing devices via an intranet. An intranet uses the same Internet protocol suit as the Internet. Two of the most important elements in the suit are the transmission control protocol (TCP) and the Internet protocol (IP).

It should be apparent that embodiments of the present disclosure can be implemented in a client-server environment such as that shown in FIG. 5. Alternatively, embodiments of the present disclosure can be implemented using other environments, e.g., a peer-to-peer environment as one non-limiting example. In accordance with one or more embodiments, functionality provided by one or more of the embodiments discussed herein can be performed at server 502, user computer 504, or some combination of server 502 and user computer 504. By way of a non-limiting example, server 502 can serve user-targeted listings to user computer 504, and identify the user-targeted listings for communication to a user using user computer 504. Server 502 can be configured to receive information from the user computer 504 that can be collected and used to identify the user-targeted listings. In accordance with one or more embodiments, a user computer 504 can be configured to include a component, e.g., an agent, that collects the targeting information, and forward the information to server 502.

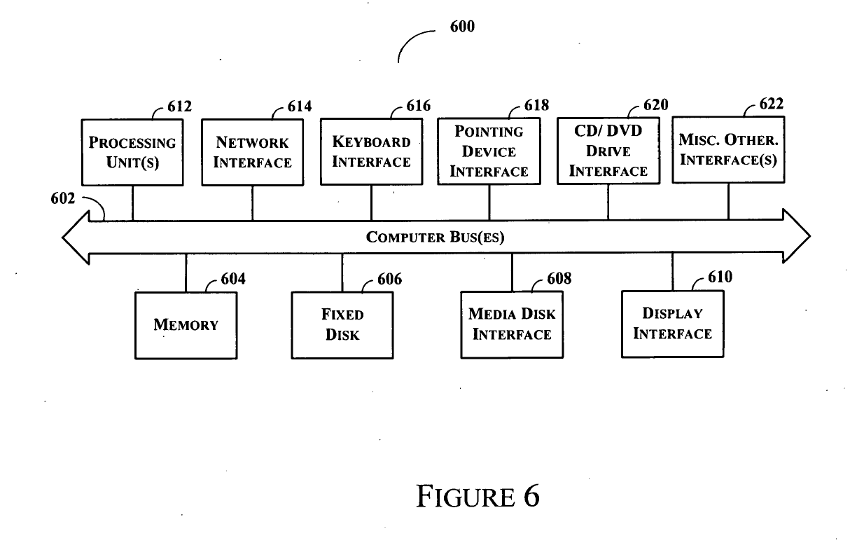

FIG. 6 is a detailed block diagram illustrating an internal architecture of a computing device, such as server 502 and/or user computing device 504, in accordance with one or more embodiments of the present disclosure. As shown in FIG. 6, internal architecture 600 includes one or more processing units (also referred to herein as CPUs) 612, which interface with at least one computer bus 602. Also interfacing with computer bus 602 are fixed disk 606, network interface 614, memory 604, e.g., random access memory (RAM), run-time transient memory, read only memory (ROM), etc., media disk drive interface 608 as an interface for a drive that can read and/or write to media including removable media such as floppy, CD-ROM, DVD, etc. media, display interface 610 as interface for a monitor or other display device, keyboard interface 616 as interface for a keyboard, pointing device interface 618 as an interface for a mouse or other pointing device, and miscellaneous other interfaces not shown individually, such as parallel and serial port interfaces, a universal serial bus (USB) interface, and the like.

Memory 604 interfaces with computer bus 602 so as to provide information stored in memory 604 to CPU 612 during execution of software programs such as an operating system, application programs, device drivers, and software modules that comprise program code, and/or computer-executable process steps, incorporating functionality described herein, e.g., one or more of process flows described herein. CPU 612 first loads computer-executable process steps from storage, e.g., memory 604, fixed disk 606, removable media drive, and/or other storage device. CPU 612 can then execute the stored process steps in order to execute the loaded computer-executable process steps. Stored data, e.g., data stored by a storage device, can be accessed by CPU 612 during the execution of computer-executable process steps.

Persistent storage, e.g., fixed disk 606, can be used to store an operating system and one or more application programs. Persistent storage can also be used to store device drivers, such as one or more of a digital camera driver, monitor driver, printer driver, scanner driver, or other device drivers, web pages, content files, playlists and other files. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

For the purposes of this disclosure a computer readable medium stores computer data, which data can include computer program code executable by a computer, in machine readable form. By way of example, and not limitation, a computer readable medium may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A method comprising:
updating and maintaining a listing database by a listing service, wherein the listing database includes a plurality of employment listings;
receiving, at the listing service, first interaction data that indicates a first interaction between a first user and a first Web page that is requested by the first user and generated by a first service, wherein the first interaction data comprises a transfer of information between the first service and the first user, without a transfer of information from the first user to the listing service;
determining, at the listing service, based on the first interaction data, a first qualification of the first user;
determining, at the listing service, based on the first qualification and the listing database, a first employment listing that may be of interest to the first user;
transmitting, to a notification service, the first employment listing to be displayed to the first user;
determining that the first user requested a second Web page; and
in response to determining that the first user requested the second Web page, causing the first employment listing to be displayed with the second Web page.

2. The method of claim 1 wherein the first interaction data comprises an input of text by the first user to the first Web page, without an input of text by the first user to the listing service.

3. The method of claim 1 wherein the first Web page is hosted by a first server that is separate from a second server that is associated with the listing service.

4. The method of claim 1 further comprising:
determining to include, with the second Web page, the first employment listing that was determined by the listing service; and
generating, by a second service, the second Web page with the first employment listing.

5. The method of claim 1 further comprising:
causing a link to a third Web page to be included in the second Web page, wherein the third Web page includes information stored in the listing database, including at least one of an employment title, an employment location, and employment keyword.

6. The method of claim 1 wherein the first user does not directly provide the listing service with information.

7. The method of claim 1 wherein the first Web page comprises content unrelated to employment searching.

8. The method of claim 1 wherein the first interaction data comprises information supplied by the first user's device and comprises identifying information used by the first Web page to route content from a server of the first Web page to the first user's device.

9. The method of claim 1 wherein:
the first interaction data comprises an identifier assigned by the first service to the first user; and
determining the first qualification of the first user further comprises, obtaining, based on the identifier assigned by the first Web page to the first user, information that the first user supplied to a service that generated the first Web page, before the first user visited the first Web page.

10. The method of claim 1 wherein the first Web page is generated by a service that is different than the listing service.

11. The method of claim 1 further comprising:
determining, at the listing service, based on the first qualification, a second employment listing that may be of interest to the first user; and
selecting, by the listing service, the first employment listing but not the second employment listing to be displayed to the first user.

12. The method of claim 1 further comprising storing, in a target database, the first qualification associated with the first user, wherein the target database is separate from the listing database.

13. The method of claim 1 wherein the first interaction data comprises a plurality of information used by the listing service to determine the first and second employment listings.

14. The method of claim 13 wherein the plurality of information comprises:
first piece of information that is supplied by a computing device of the first user as part of requesting to view the first Web page,
second piece of information that is supplied by the first user as a text entry to the first Web page when viewing the first Web page, and
third piece of information that is an identifier of the first Web page that is supplied by the first Web page visited by the first user.

15. The method of claim 1 wherein the first service which generates the first Web page comprises a search engine.

16. The method of claim 1 wherein the first employment listing comprises a digital link to a job position that is maintained by the listing service.

17. A system comprising:
one or more processors; and
one or more computer-readable media carrying instructions which, when executed by the one or more processors, cause:
updating and maintaining a listing database by a listing service, wherein the listing database includes a plurality of employment listings;
receiving, at the listing service, first interaction data that indicates a first interaction between a first user and a first Web page that is requested by the first user and generated by a first service, wherein the first interaction data comprises a transfer of information between the first service and the first user, without a transfer of information from the first user to the listing service;
determining, at the listing service, based on the first interaction data, a first qualification of the first user;
determining, at the listing service, based on the first qualification and the listing database, a first employment listing that may be of interest to the first user;
transmitting, to a notification service, the first employment listing to be displayed to the first user;
determining that the first user requested a second Web page; and
in response to determining that the first user requested the second Web page, causing the first employment listing to be displayed with the second Web page.

18. The system of claim 17 wherein the one or more computer-readable media carrying instructions further cause:
determining that the first user requested a second Web page without a corresponding request by the first user to the listing service for a Web page;
in response to determining that the first user requested the second Web page, displaying with the second Web page the first employment listing; and
in response to determining that the first user requested the second Web page, displaying at the second Web page the first employment listing.

19. The system of claim 17 wherein the one or more computer-readable media carrying instructions further cause:
transmitting by the first user a request from the first user to a second service, which is different than the listing service, for information from the second service; and
when generating the second Web page by the second service, determining that the first employment listing from the listing service may be of interest to the first user.

20. The system of claim 17 wherein the first user is not a registered user of the listing service.
